(19) United States
(12) Patent Application Publication
(10) Pub. No.: US 2026/0330733 A1
(43) Pub. Date: Oct. 22, 2026

(54) POINT CORRESPONDENCE-GUIDED MOTION TRANSFER IN VIDEO GENERATION

(71) Applicant: Adobe Inc., San Jose, CA (US)

(72) Inventors: Duygu Ceylan Aksit, London (GB); Niloy Jyoti Mitra, Potters Bar (GB); Hyeonho Jeong, Seoul (KR); Chun-hao Huang, London (GB)

(73) Assignee: Adobe Inc., San Jose, CA (US)

(21) Appl. No.: 19/182,244

(22) Filed: Apr. 17, 2025

(51) Int. Cl. G06T 13/00; G06T 7/246; G06T 7/269

(52) U.S. Cl. CPC G06T 13/00; G06T 7/246; G06T 7/269; G06T 2207/10016; G06T 2207/20081

(57) ABSTRACT

In implementations of techniques and systems for employing point correspondence-guided motion transfer in video generation, a processing device receives a first digital video having a plurality of frames depicting a reference movement of a first object and a prompt indicating a second object. A machine-learning model determines point trajectories across the plurality of frames of the first digital video that track the reference movement of the first object. The machine-learning model then determines a correspondence loss that quantifies a spatial correspondence of the point trajectories. Using the correspondence loss as a guide for maintaining spatial correspondence across a plurality of frames, the machine-learning model generates a second digital video as having movement of the second object based on the reference movement of the first object.

### BACKGROUND

Diffusion-based video generators are available to create video content with different subjects or scenes from text or image prompts. For example, diffusion-based machine-learning models have been developed to generate videos that include sophisticated motion capture and character animation. However, these conventional diffusion models often introduce appearance drift into the generated videos, where visual elements gradually change, mutate, or degrade over time, causing visible inconsistencies in the depicted objects.

### SUMMARY

Techniques and systems for employing point correspondence-guided motion transfer in video generation are described. In one example, a processing device receives an input includes a first digital video and a prompt. The first digital video includes multiple frames depicting a first object with a reference movement. The prompt is natural language text or an image that indicates a second object to be depicted in a second digital video generated by a machine-learning model. The machine-learning model includes a text-to-video or image-to-video diffusion model.

The machine-learning model uses an optical flow procedure to determine a set of point trajectories across the frames of the first digital video. Each point trajectory includes a point in one frame that corresponds to a matching point in another frame. A denoiser (e.g., a U-Net denoiser) of the machine-learning model uses a correspondence loss to determine an updated latent representation of the first object in a latent space. The correspondence loss quantifies a spatial correspondence of the set of point trajectories. The updated latent representation is iteratively determined before each denoising step.

The machine-learning model uses the first object's updated latent representation to guide the second object's movement during an inference stage based on the prompt. The machine-learning model is trained to minimize diffusion loss and correspondence loss. The processing device then presents the second digital video of the second object with the reference movement to a user via a display device.

This Summary introduces a simplified selection of concepts described below in the Detailed Description. As such, this Summary is not intended to identify essential features of the claimed subject matter or to aid in determining its scope.

### BRIEF DESCRIPTION OF THE DRA WINGS

The detailed description is described with reference to the accompanying figures Entities represented in the figures are indicative of one or more entities and thus reference is made interchangeably to single or plural forms of the entities in the discussion.

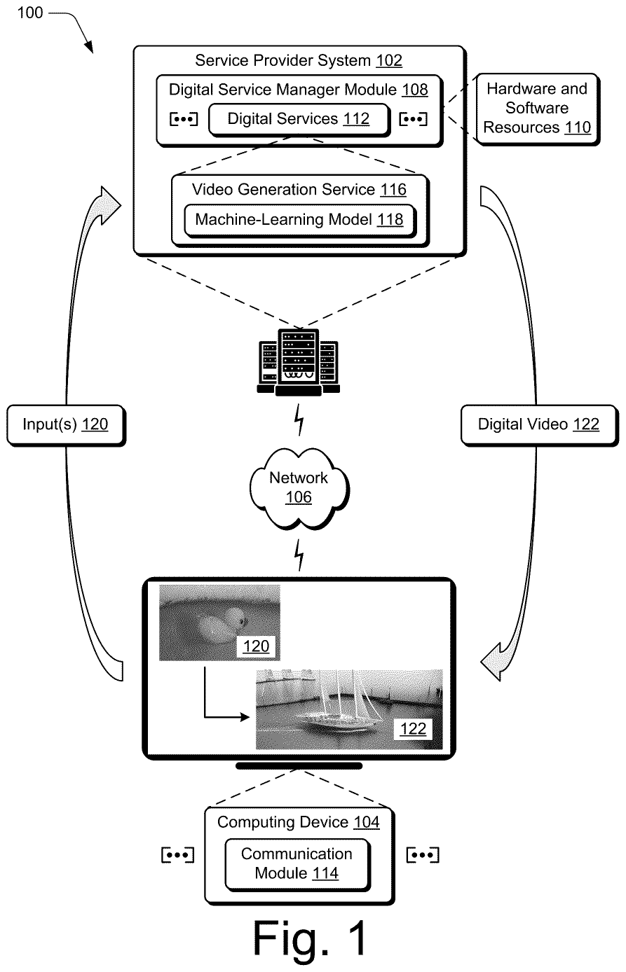

FIG. 1 is an illustration of a digital medium environment in an example implementation that is operable to employ point correspondence-guided motion transfer in video generation as described herein.

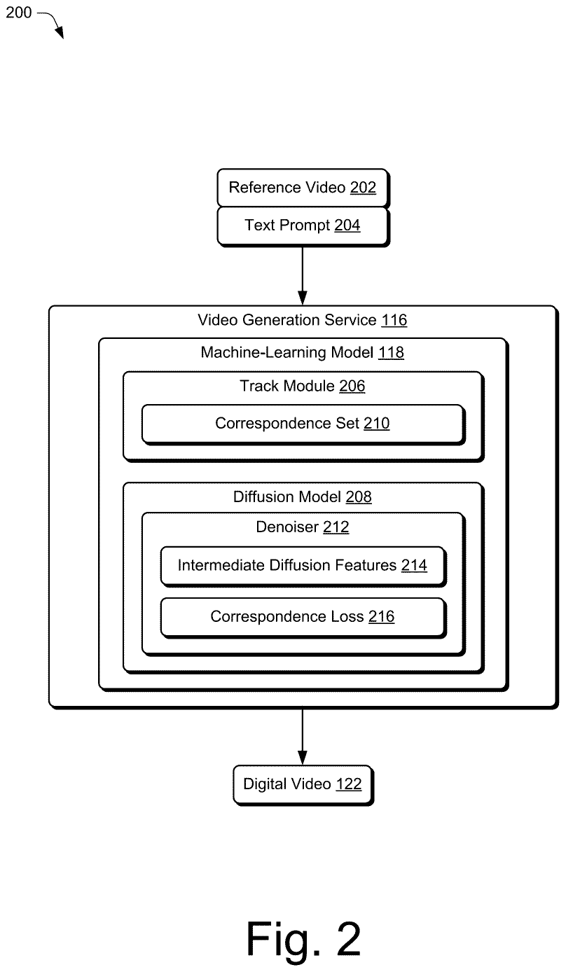

FIG. 2 depicts a system in an example implementation showing operation of a video generation system of FIG. 1 in greater detail as employing the techniques described herein.

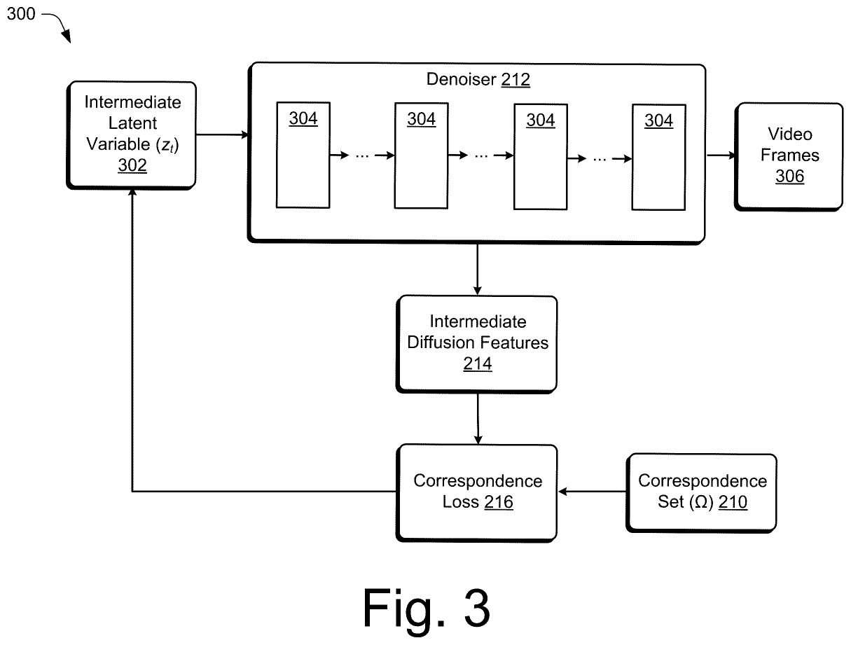

FIG. 3 is a flow diagram depicting a procedure in an example implementation of operations performable to employ point correspondence-guided motion transfer in video generation.

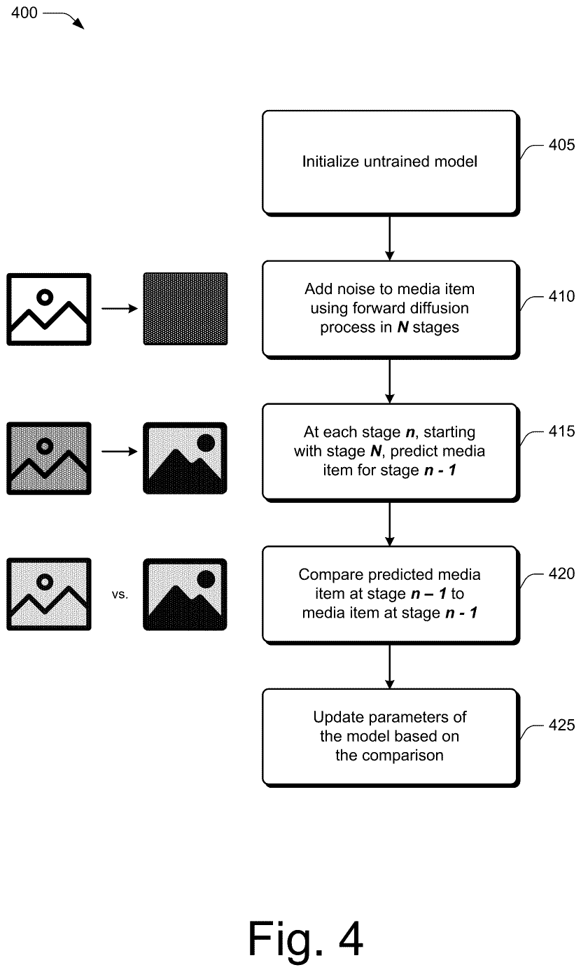

FIG. 4 shows an example of a method for training a diffusion model according to aspects of the present disclosure.

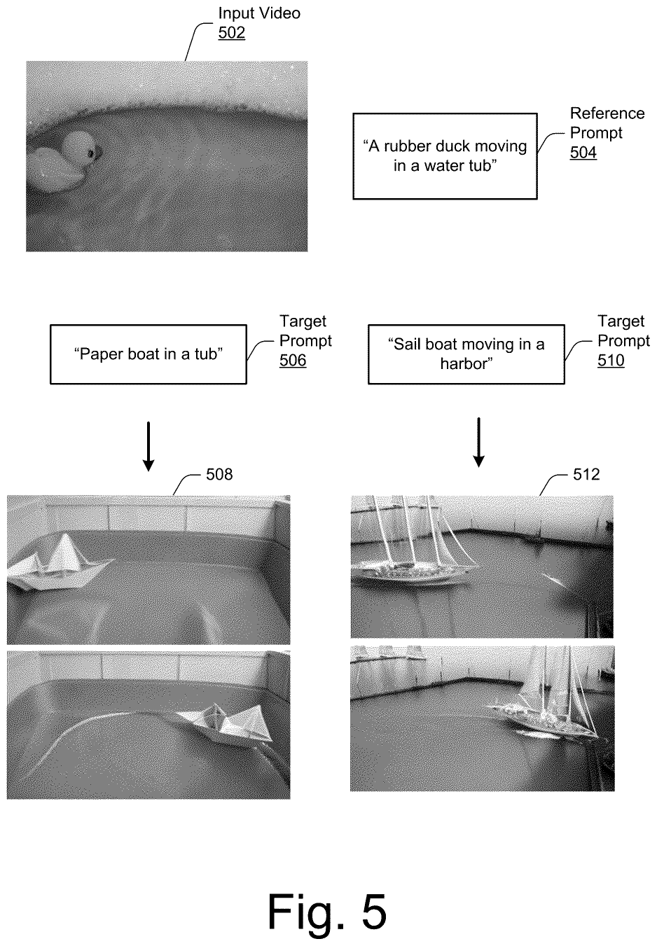

FIG. 5 depicts examples of digital videos generated using point correspondence-guided motion transfer techniques, as described herein.

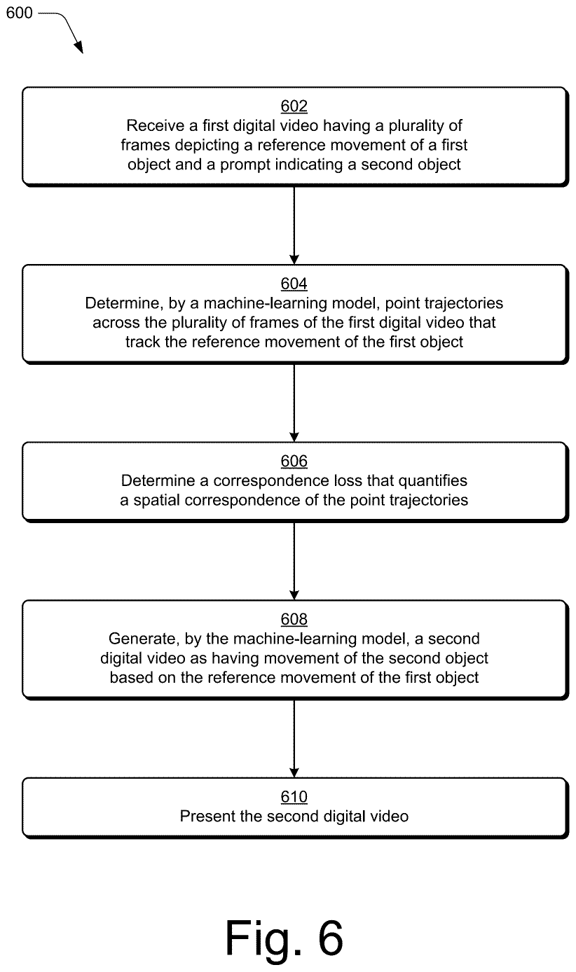

FIG. 6 is a flow diagram depicting an algorithm as a step-by-step procedure in an example implementation of operations performable for point correspondence-guided motion transfer in video generation.

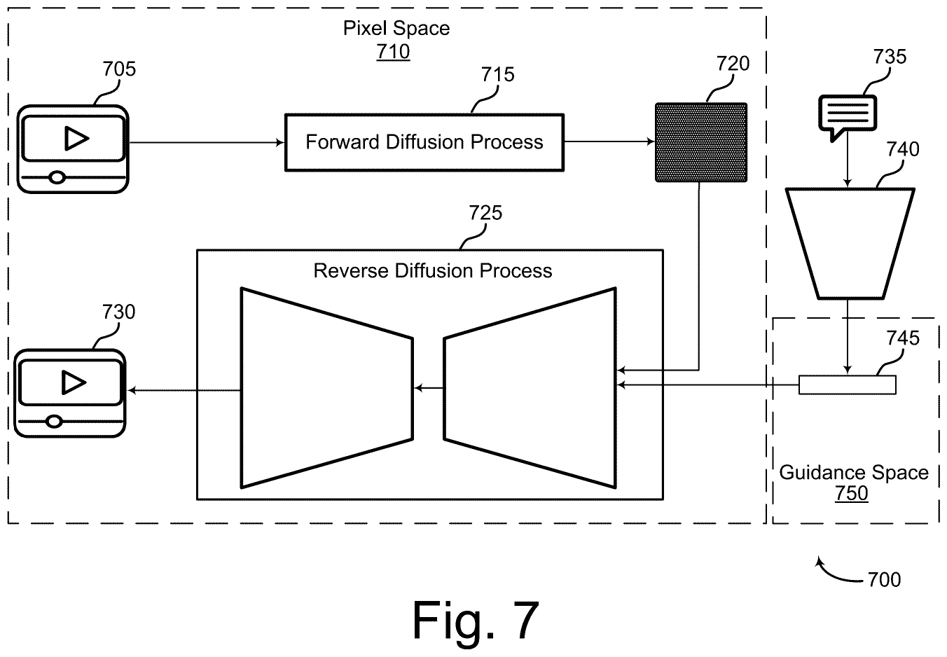

FIG. 7 shows an example of a guided diffusion model according to aspects of the present disclosure.

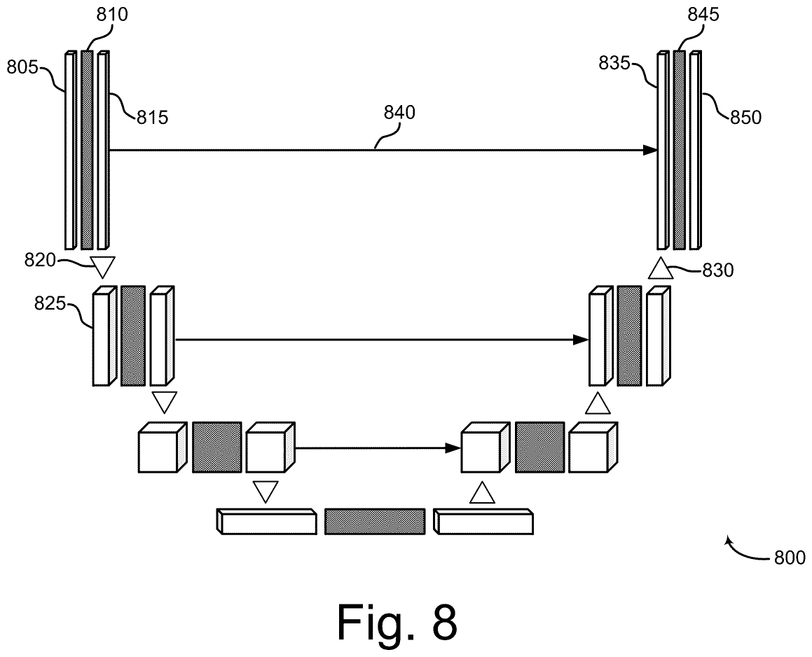

FIG. 8 shows an example of a U-Net according to aspects of the present disclosure.

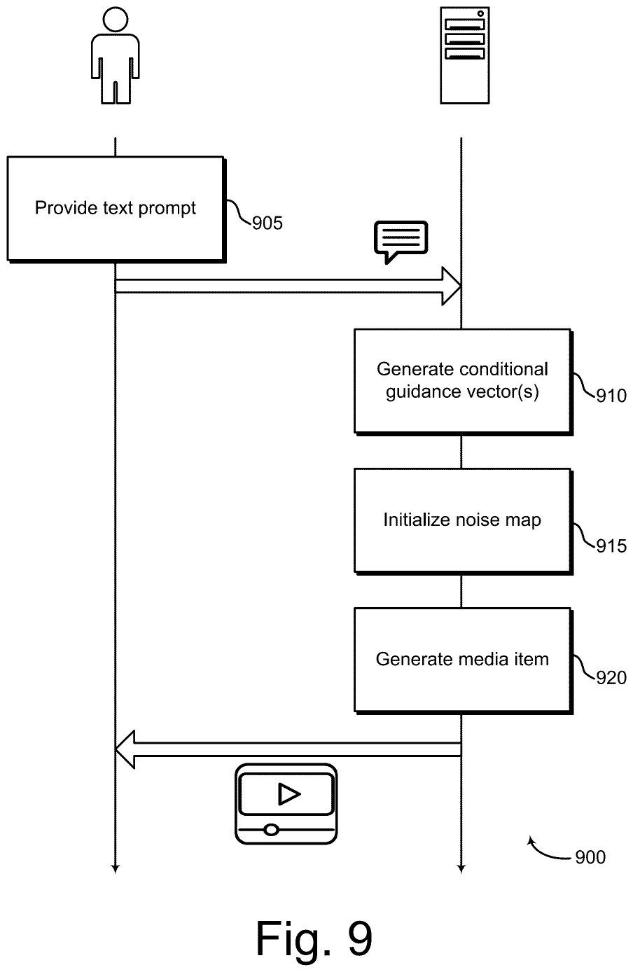

FIG. 9 shows an example of a method for conditional media generation according to aspects of the present disclosure.

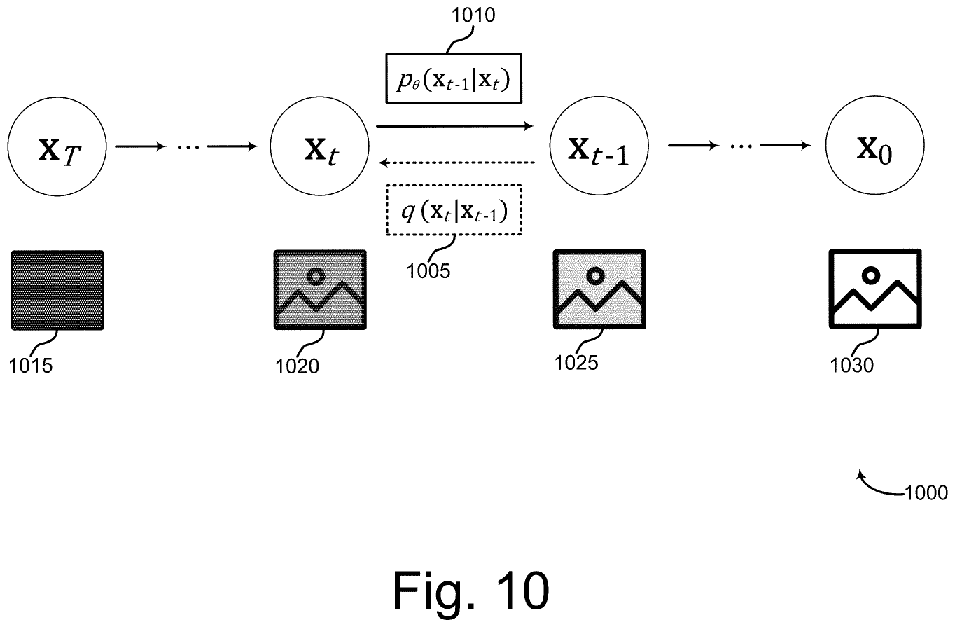

FIG. 10 shows a diffusion process according to aspects of the present disclosure.

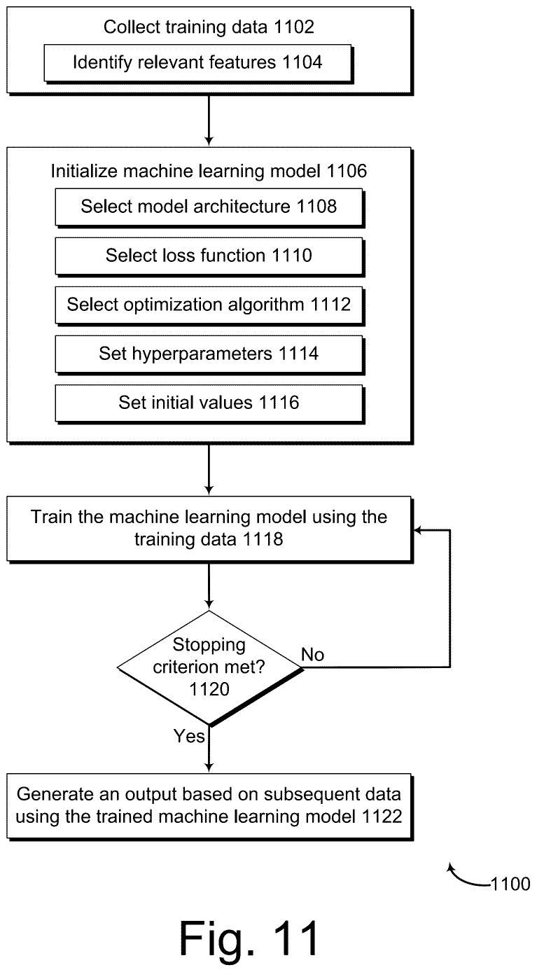

FIG. 11 shows a flow diagram depicting an algorithm as a step-by-step procedure for training a machine-learning model according to aspects of the present disclosure.

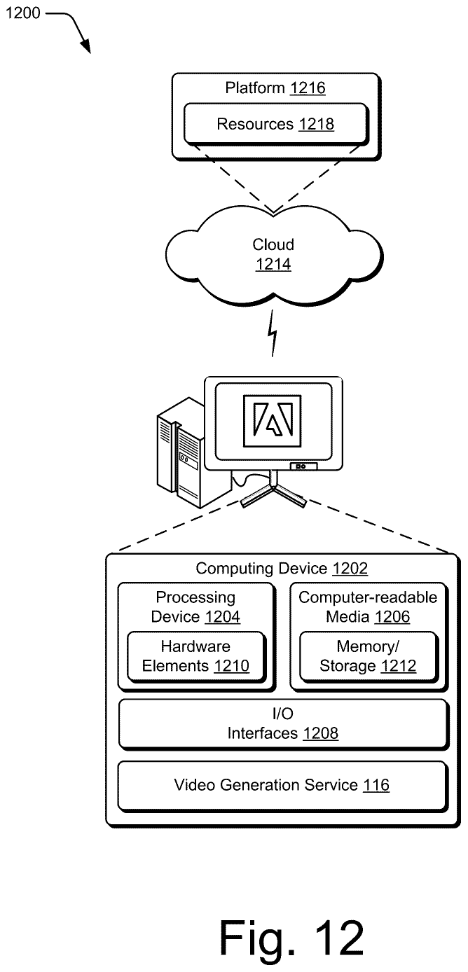

FIG. 12 illustrates an example system including various components of an example device that can be implemented as any type of computing device as described and/or utilize with reference to the previous figures to implement embodiments of the techniques described herein.

### DETAILED DESCRIPTION

### Overview

Generating videos with motion is employed by both the movie industry and the visual effects community. One approach is to use text-to-video (T2V) generative diffusion models that generate videos from text prompts that specify the target content and motions. While such machine-learning models have improved in generating imaginative videos based on text depictions, conventional T2V models struggle with precise motion control and involve complex prompt engineering. In other words, these conventional creation techniques are limited by a user's ability to define in natural language “what is to be performed” as part of the input to generate desired motions and details.

Accordingly, techniques and systems for point correspondence-guided motion transfer for diffusion models in video generation are described as implemented by a video generation service that leverages correspondence supervision to address these and other technical challenges in generating digital videos. Diffusion models generally utilize video diffusion loss (e.g., also referred to as denoising score matching) in a pixel or latent space to supervise the video generation.

In one example, a processing device receives an input with a first digital video and a prompt. The first digital video includes multiple frames depicting a first object with a reference movement. The prompt is natural language text or an image that indicates a second object to be depicted in a second or target digital video generated by a machine-learning model.

The machine-learning model uses an optical flow procedure to determine a set of point trajectories across the frames of the first digital video. Each point trajectory includes a point in one frame corresponding to a matching point in another frame. A denoiser (e.g., a U-Net denoiser) of the machine-learning model uses gradients of the correspondence loss to determine an updated latent representation of the first object in a latent space. During a subsequent inference stage, the machine-learning model uses the correspondence loss as a guide for maintaining the spatial correspondence of the second object's movement based on the prompt. In this way, the machine-learning model generates videos with complex and visibly-believable movement by transferring motion from a reference object to new objects, even if the objects are disparate in nature.

The following discussion describes an example environment that employs the techniques described herein. Example procedures are also described as performable in the example environment and other environments. Consequently, the performance of the example procedures is not limited to the example environment, and the example environment is not limited to the performance of the example procedures.

### Example Digital Video Generation Environment

FIG. 1 is an illustration of a digital medium environment 100 in an example implementation that is operable to employ point correspondence-guided motion transfer in video generation as described herein. The illustrated digital medium environment 100 includes a service provider system 102 and a computing device 104 that are communicatively coupled, one to another, via a network 106. Computing systems for the service provider system 102 and the computing device 104 are configurable in a variety of ways. For instance, computing device 104 is associated with a user, and service provider system 102 is a remote computing system (e.g., one or more servers) configured to employ the described techniques and systems for point correspondence-guided motion transfer in video generation.

A computing system, for instance, is configurable as a desktop computer, laptop computer, mobile device (e.g., assuming a handheld configuration such as a tablet or mobile phone), server, and so forth. Thus, the service provider system 102 or the computing device 104 is capable of ranging from a full-resource device with substantial memory and processor resources (e.g., servers and personal computers) to a low-resource device with limited memory and/or processing resources (e.g., some mobile devices). Additionally, although a single computing device is shown for the computing device 104 and described in instances in the following discussion, a computing system is also representative of a plurality of different devices, such as multiple servers utilized by a business to perform operations “over the cloud” for the service provider system 102 and as further described in relation to FIG. 7.

The service provider system 102 includes a digital service manager module 108 implemented using hardware and software resources 110 (e.g., a processing device and computer-readable storage medium) to support one or more digital services 112. Digital services 112 are made available remotely via the network 106 to computing devices, e.g., computing device 104.

Digital services 112 are scalable through implementation by the hardware and software resources 110 and support a variety of functionalities, including accessibility, verification, real-time processing, analytics, load balancing, and so forth. Examples of digital services include a digital content creation service, social media service, streaming service, digital content repository service, content collaboration service, and so on. Accordingly, in the illustrated example, a communication module 114 (e.g., browser, network-enabled application, and so on) is utilized by the computing device 104 to access the digital services 112 via the network 106. A result of processing using the digital services 112 is then returned to the computing device 104 via the network 106.

In the illustrated digital medium environment 100, the digital services 112 include a video generation service 116 for generating videos. Although illustrated as implemented remotely by the service provider system 102, functionality of the video generation service 116 is also configurable for implementation locally, e.g., as part of the communication module 114 at the computing device 104. The video generation service 116 is configured to leverage generative artificial intelligence (AI) techniques implemented using a machine-learning model 118 (e.g., one or more diffusion models) to generate digital videos.

To do so, the video generation service 116 uses the machine-learning model 118 to process inputs 120 to generate a digital video 122. The inputs 120 include, for example, a prompt describing in plain language (e.g., via text, voice, or other means) a target object to perform a reference movement or an image of a target object. The inputs 120 also include a reference digital video that depicts a reference object performing the reference movement in multiple frames.

As previously described, some conventional generative digital video editing techniques that employ diffusion models to extend text-to-image models to the video domain by incorporating temporal layers to facilitate interactions across video frames. Some conventional techniques have adopted cascaded approaches to produce spatially and temporally high-resolution videos, while others have utilized lower-dimensional latent space modeling to reduce computational demands. However, appearance drift remains a persistent issue in conventional video models, even with increased training data and more advanced architectures.

In particular, the machine-learning model 118 generates the digital video 122 by transferring the reference motion of objects in the reference video (e.g., a rubber duck moving on water in a bathtub) to the target object(s) (e.g., a sailboat in a harbor) in the generated digital video 122. The machine-learning model 118 extracts the motion trajectory of one or more objects in the reference video as represented by point correspondences across frames. A supervisory signal is then used during the generation process to generate the digital video 122 that follows the extracted motion trajectory and applies it to the target object(s).

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Video Generation

FIG. 2 depicts a system 200 in an example implementation showing operation of a video generation service 116 of FIG. 1 in greater detail as employing the techniques described herein. FIG. 3 is a flow diagram depicting a procedure 300 in an example implementation of operations performable to employ point correspondence-guided motion transfer in video generation.

The inputs to the video generation service 116 of FIG. 1 include a reference video 202 and a text prompt \hat{γ} 204. The reference video 202 includes a depiction of a reference object and a reference movement, which includes camera movement and/or movement of the reference object within the depicted environment. The text prompt 204 includes a description of a target object to be displayed in the digital video 122 with the reference movement.

The video generation service 116 includes the machine-learning model 118 of FIG. 1, which includes a track module 206 and a diffusion model 208. Given the reference video 202 and a text prompt 204, the video generation service 116 uses the machine-learning model 118 to generate the digital video 122 that reflects the target object in the text prompt 204 and preserves the reference movement (e.g., reference object and/or camera motion), while allowing for changes in object shape, identity, and background.

The track module 206 is used to transfer the reference movement in the reference video 202

$$( {z}_{0}^{1 : N} ) ,$$

where N is the number of frames, to the target object in the generated digital video 122. The track module 206 determines or computes a dense set of point trajectories within

$${z}_{0}^{1 : N}$$

using an optical flow procedure (e.g., recurrent all-pairs field transforms). For example, the track module 206 employs a deep network architecture to extract per-pixel features, build multi-scale four-dimensional correlation volumes for each pair of pixels, and iteratively update a flow field through a recurrent unit that performs lookups on the correlation volumes, which is described in greater detail in Zachary Teed and Jia Deng, “Raft: Recurrent all-pairs field transforms for optical flow,” in Computer Vision-ECCV 2020: 16th European Conference, Glasgow, UK, August 23-28, 2020, Proceedings, Part II, pp. 402-419 (2020), which is incorporated by reference in its entirety herein. Leveraging the sub-pixel accuracy of optical flow procedures, the track module extracts short-term tracks by chaining point displacements across frames, resulting in a correspondence set 210Ω={(xⁱ, x^{j})}, where a point xⁱ in frame i corresponds to a matching point x^{j} in frame j and vice versa (e.g., assuming that the optical-flow tracklet between the frames is cycle consistent).

A “diffusion model” is a generative machine-learning model for digital content creation (e.g., digital videos 122). To train a diffusion model, noise is generally added to training data samples (e.g., using a noise module) until the data within the training data samples is obscured. The diffusion model is then trained self-supervised to reverse this process (e.g., using a denoiser 212) based on training data with a text or image prompt describing the digital content to be created to generate data samples as the digital content corresponding to the text or image prompt. Additional details of training the video diffusion model 208 are described in greater detail below with respect to FIG. 4.

Text-to-video (T2V) diffusion models generate digital videos from a text prompt, which is an example of input 120. Similarly, image-to-video (I2V) diffusion models generate digital videos from an image prompt, which is another example of input 120. The diffusion model 208 is generally a T2V model. In another implementation, the diffusion model 208 is an I2V model or a hybrid model trained to receive image prompts, text prompts, or a combination thereof as input 120.

In general, a diffusion model trains a three-dimensional (3D) UNet ∈_{θ} (e.g., the denoiser 212) to generate videos in a series of denoising steps conditioned on the input 120 (e.g., a text, image, or text-plus-image prompt). The 3D UNet employs a convolutional neural network (CNN) architecture and generally includes spatial self-frame and cross-frame attention layers, two-dimensional (2D) and 3D convolutions, and temporal cross-frame attention layers.

Starting from random Gaussian noise, diffusion models aim to generate clean videos via an iterative denoising process (e.g., using the denoiser 212). This process reverses a fixed, time-dependent diffusion forward process, which gradually corrupts the data by adding Gaussian noise via a noise module. While the described techniques are applicable to general video diffusion models, in one implementation the architecture of the diffusion model 208 is based on a latent video diffusion model. The diffusion process operates in the lower-dimensional latent space of a pre-trained variational autoencoder (VAE), which includes an encoder ε(⋅) and a decoder [symbol] (⋅).

Given a clean sample

$${x}_{0}^{1 : N} ∼ {p}_{data} ( x )$$

of an N-frame video sequence, the encoder encodes the frames into the latent space as

$${z}_{0}^{1 : N} = ℰ ( {x}_{0}^{1 : N} ) .$$

A noise module adds noise (e.g., Gaussian noise) ∈~ [symbol] (0, I) to the latents to produce an intermediate latent variable via the forward process

$${z}_{t}^{1 : N} = {α}_{t} {z}_{0}^{1 : N} + {σ}_{t} ϵ ,$$

where t represents the diffusion timestep, and αₜ, σₜ are the discretized noise scheduler parameters.

During the reverse diffusion process, the denoiser ∈_{θ} 212 is trained to introduce a correspondence loss 216 to optimize the intermediate latent variable

$${z}_{t}^{1 : N}$$

before denoising step. The correspondence loss 216 quantifies a spatial correspondence of the point trajectories across the video frames. The diffusion model 208 feeds the intermediate latent variable

$${z}_{t}^{1 : N}$$

302 at timestep t into the video diffusion U-Net of the denoiser E, 212 to extract intermediate diffusion features f^{1:N} 214 at one or more of the spatial-temporal blocks 304. The intermediate diffusion features 214 encode semantic information shared across objects from different domains. Using the semantic features and the correspondence set £2 210, the diffusion model 208 defines and determines the correspondence loss 216.

Given the correspondence set Ω 210, the denoiser 212 uses the intermediate diffusion features 214 f^{1:N}∈ [symbol] ^{N×H×W×C} a query point

$${x}_{q}^{i}$$

along with its ground-truth target point

$${x}_{trg}^{j}$$

to compute the correspondence loss 216. Given the query point feature fⁱ(x_{g})∈ [symbol] ^{1×1×C} and the target feature map f^{j}∈ [symbol] ^{H×W×C}, the denoiser 212 calculates the cost volume S∈ [symbol] ^{H×W×1} as follows:

S(p)=cos_sim(fⁱ(x_{q}),f^{j}(p))

where cos_sim denotes cosine similarity. The predicted target point \hat{x}_{trg} is then determined using the differentiable soft-argmax operation:

$${\hat{x}}_{trg} = \frac{{\sum }_{p ∈ {Ω}^{′}} S ( p ) \cdot {x}_{p}}{{\sum }_{p ∈ {Ω}^{′}} S ( p )}$$

where Ω′={p:∥xₚ−xₚ_{ₘₐₓ}∥₂≤R}. In one implementation, R is set to 35. Thus, the target point prediction is expressed as

$${\hat{x}}_{trg} = ξ ( {x}_{q}^{i} , j , {f}^{1 : N} ) ,$$

and the predicted tracklet for

$${x}_{q}^{i}$$

is given by

$${𝒯}_{{x}_{q}^{i}} = \{ {\hat{x}}_{n} : {\hat{x}}_{n} = ξ ( {x}_{q}^{i} , n , {f}^{1 : N} ) , n = 1 , … , N \} .$$

Finally, the denoiser 212 determines the correspondence loss [symbol] _{corr} 216 using the Huber loss L_{H}:

$${ℒ}_{corr} = {\sum }_{( {x}_{q}^{i} , {x}_{trg}^{j} ) ∈ Ω} {L}_{H} ( ξ ( {x}_{q}^{i} , j , {f}^{1 : N} ) , {x}_{trg}^{j} ) + {L}_{H} ( ξ ( {x}_{trg}^{j} , i , {f}^{1 : N} ) , {x}_{q}^{i} )$$

Once the intermediate diffusion features f^{1:N} 214 are extracted and the correspondence loss 216 is computed, the diffusion model 208 updates the intermediate latent variable

$${z}_{t}^{1 : N}$$

using the gradients of the correspondence loss ∇_{z}_{ₜ} [symbol] _{corr}. The denoiser 212 then uses the updated latent variable

$${\hat{z}}_{t}^{1 : N}$$

in the denoising step at timestep t:

$${z}_{t - 1}^{1 : N} = Φ ( {\hat{z}}_{t}^{1 : N} , \hat{y} , t )$$

where Φ is the denoising operator from the denoiser 212. The optimize-denoise processes illustrated in FIG. 3 is applied iteratively throughout the reverse diffusion steps. Once the clean latent

$${z}_{0}^{1 : N}$$

(e.g., video frames 306 of FIG. 3) is obtained, the decoder [symbol] maps the video frames 306 to the higher-dimensional pixel space

$${x}_{0}^{1 : N} = 𝒟 ( {z}_{0}^{1 : N} ) ,$$

which is output as the digital video 122.

FIG. 4 shows an example of a method 400 for training a diffusion model according to aspects of the present disclosure. The method 400 represents an example for training a diffusion model 208 as described above with reference to FIGS. 2 and 3. In some examples, these operations are performed by a system including a processor executing a set of codes to control functional elements of an apparatus, such as the machine-learning model 118 described in FIG. 1.

Additionally, or alternatively, certain processes of method 400 are performable using special-purpose hardware. Generally, these operations are performed according to the methods and processes described in accordance with aspects of the present disclosure. In some cases, the operations described herein are composed of various substeps or are performed in conjunction with other operations.

At operation 405, the user initializes an untrained model (e.g., a T2V or I2V diffusion model). Initialization includes defining the architecture of the model and establishing initial values for the model parameters. In some cases, the initialization includes defining hyper-parameters such as the number of layers, the resolution and channels of each layer blocks, the location of skip connections, and the like. In other cases, the initialization includes utilizing a previously-trained or previously-defined model.

At operation 410, the system adds noise to a media item using a forward diffusion process in N stages. In some cases, the forward diffusion process is a fixed process where Gaussian noise is successively added to media item. In latent diffusion models, the Gaussian noise is successively added to features in a latent space.

At operation 415, the system at each stage n, starting with stage N, uses a reverse diffusion process to predict the output or features at stage n−1. For example, the reverse diffusion process predicts the noise that was added by the forward diffusion process, and the predicted noise is removed from the noise input to obtain the predicted output. In some cases, an original media item is predicted at each stage of the training process.

At operation 420, the system compares predicted output (or features) at stage n−1 to an actual media item (or features), such as the output at stage n−1 or the original input. For example, given observed data x, the diffusion model is trained to minimize the variational upper bound of the negative log-likelihood −log p_{θ}(x) of the training data.

In particular, the denoiser blocks up to b^{k} (e.g., b¹, . . . , b^{k}) are optimized using a joint loss, [symbol] = [symbol] _{diff}+Δ [symbol] _{corr}, with λ empirically set to 8 in one implementation, [symbol] _{diff} being a diffusion loss, and [symbol] _{corr} being a correspondence loss. The diffusion loss quantifies noise removal and data reconstruction in generated videos. In one implementation, a refiner network of the diffusion model is initialized as an identity mapping and is trained with the correspondence loss (e.g., λ [symbol] _{corr}) to learn how to project raw latent features into correspondence-enriched refined latent features. To prevent the refiner network from being influenced by the diffusion loss [symbol] _{diff}, the gradients are detached before being fed into a zero convolution layer of the denoiser backbone. The zero convolution layer and denoiser blocks after b^{k} are trained using the diffusion loss, with the zero convolution layer learning to fuse the refined latent features with the raw latent features and the denoiser blocks after b^{k} learning to utilize the fused features for video generation.

At operation 425, the system updates parameters of the model based on the comparison. For example, parameters of a U-Net are updated using gradient descent. Time-dependent parameters of the Gaussian transitions are also learned.

FIG. 5 depicts examples of digital videos generated using point correspondence-guided motion transfer techniques, as described herein. The diffusion model (e.g., the diffusion model 208 of FIG. 2) receives as inputs 120 an input video 502, a reference prompt 504, and a target prompt 506 or 510. The input video 502 depicts a yellow rubber duck moving along the water's surface in a bathtub. The reference prompt 504 provides a short caption or description of the input video 502: “a rubber duck moving in a water tub.”

In a first example, the diffusion model also receives as input 120 the target prompt 506, which requests a video of a “paper boat in a tub.” The diffusion model uses a correspondence set extracted from the input video 502 as a supervisory signal in generating the digital video 508, which depicts a paper boat moving along the water in a small plastic tub.

In a second example, the diffusion model receives as an additional input 120 the target prompt 510, which requests a video of a “sailboat moving in a harbor.” Similarly, the diffusion model uses the extracted correspondence set from the input video 502 to guide the motion of a sailboat during the generation of digital video 512, which shows a sailboat navigating a harbor. In both examples, the diffusion model provides zero-shot motion transfer that accurately captures the reference movement of the rubber duck in the input video 502 using the correspondence set associated with the duck's movement across video frames.

### Example Video Generation Procedures

The following discussion describes video generation techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm, e.g., responsive to execution of the instructions. In portions of the following discussion, reference will be made to FIGS. 1-5.

FIG. 6 is a flow diagram depicting an algorithm as a step-by-step procedure 600 in an example implementation of operations performable for point correspondence-guided motion transfer in video generation. To begin in this example, a first digital video having a plurality of frames depicting a reference movement of a first object and a prompt indicating a second object is received (block 602).

In one implementation, the input includes a text prompt with a plain language identification (e.g., in a natural language format) of the second or target object and the reference movement to be depicted or mimicked in the second digital video. The processing device utilizes a pre-trained text-to-video (T2V) diffusion model in such scenarios. In another implementation, the input includes an image of the second object and a text prompt with a plain language identification of the reference movement. In such scenarios, the processing device utilizes a pre-trained image-to-video (I2V) diffusion model. The processing device also receives a textual description of the first digital video and the first object, which the machine-learning model uses to generate the second digital video.

The machine-learning model determines point trajectories across the plurality of frames of the first digital video that track the reference movement of the first object (block 604). By way of example, each point trajectory includes a point in one frame that corresponds to a matching point in another frame. The machine-learning model uses a bidirectional optical flow procedure to determine the set of point trajectories. In particular, the machine-learning model extracts per-pixel features from the frames and builds four-dimensional correlation volumes for each pair of pixels. The machine-learning model then iteratively updates a flow field through a recurrent unit performing lookups on the four-dimensional correlation volumes.

The machine-learning model then determines a correspondence loss that quantifies a spatial correspondence of the point trajectories (block 606). For example, an updated latent representation is determined at a first time step by encoding the plurality of frames of the first video from a pixel space into the latent space to generate a latent representation of the first object. The latent representation is fed at the first time step into a denoiser of the machine-learning model to extract latent features of the first object. The denoiser determines or computes the correspondence loss based on the latent features and the set of point trajectories. Using gradients of the correspondence loss, the denoiser generates the updated latent representation and used it at the first time step. In one implementation, the updated latent representation is determined at each time step and each denoising step in the denoiser.

The machine-learning model generates a second digital video as having movement of the second object based on the reference movement of the first object (block 608). The machine-learning model uses the correspondence loss a guide for maintaining the spatial correspondence across a plurality of frames of the second digital video during the inference or generating phase. The processing device then presents the second digital video via a display device (block 610).

### Example Architecture for Pixel Diffusion

FIG. 7 shows an example of a guided diffusion model 700 according to aspects of the present disclosure. In some examples, guided diffusion model 700 describes the operation and architecture of the diffusion model 208 described with reference to FIG. 2. The guided latent diffusion model 700 depicted in FIG. 7 is an example of, or includes aspects of, a media generation model as described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided latent diffusion model 700 may take an original media item 705 in a pixel space 710 as input and apply forward diffusion process 715 to gradually add noise to the original media item 705 to obtain noisy media item 720 at various noise levels.

Next, a reverse diffusion process 725 (e.g., a U-Net) gradually removes the noise from the noisy media item 720 at the various noise levels to obtain an output media item 730. In some cases, an output media item 730 is created from each of the various noise levels. The output media item 730 can be compared to the original media item 705 to train the reverse diffusion process 725.

The reverse diffusion process 725 can also be guided based on a text prompt 735, or another guidance prompt, such as an image, a layout, a segmentation map, etc. The text prompt 735 can be encoded using a text encoder 740 (e.g., a multimodal encoder) to obtain guidance features 745 in guidance space 750. The guidance features 745 can be combined with the noisy media item 720 at one or more layers of the reverse diffusion process 725 to ensure that the output media item 730 includes content described by the text prompt 735. For example, guidance features 745 can be combined with the noisy features using a cross-attention block within the reverse diffusion process 725.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item.

### Example Architecture of a U-Net

FIG. 8 shows an example of a U-Net 800 according to aspects of the present disclosure. In some examples, U-Net 800 is an example of the component that performs the reverse diffusion process 725 of guided diffusion model 700 described with reference to FIG. 7 and includes architectural elements of the diffusion model 208 described with reference to FIG. 2. The U-Net 800 depicted in FIG. 8 is an example of, or includes aspects of, the architecture used within the reverse diffusion process described with reference to FIG. 7.

In some examples, diffusion models are based on a neural network architecture known as a U-Net. The U-Net 800 takes input features 805 having an initial resolution and an initial number of channels and processes the input features 805 using an initial neural network layer 810 (e.g., a convolutional network layer) to produce intermediate features 815. The intermediate features 815 are then down-sampled using a down-sampling layer 820 such that down-sampled features 825 features have a resolution less than the initial resolution and a number of channels greater than the initial number of channels.

This process is repeated multiple times, and then the process is reversed. That is, the down-sampled features 825 are up-sampled using up-sampling process 830 to obtain up-sampled features 835. The up-sampled features 835 can be combined with intermediate features 815 having the same resolution and number of channels via a skip connection 840. These inputs are processed using a final neural network layer 845 to produce output features 850. In some cases, the output features 850 have the same resolution as the initial resolution and the same number of channels as the initial number of channels.

In some cases, U-Net 800 takes additional input features to produce conditionally generated output. For example, the additional input features could include a vector representation of an input prompt. The additional input features can be combined with the intermediate features 815 within the neural network at one or more layers. For example, a cross-attention module can be used to combine the additional input features and the intermediate features 815.

### Example Conditional Generation Inference

FIG. 9 shows an example of a method 900 for conditional media generation according to aspects of the present disclosure. In some examples, method 900 describes an operation of the diffusion model 208 described with reference to FIG. 2 such as an application of the guided diffusion model 700 described with reference to FIG. 7. In some examples, these operations are performed by a system including a processor executing a set of codes to control functional elements of an apparatus such as the media generation model described in FIG. 7.

Additionally or alternatively, steps of the method 900 may be performed using special-purpose hardware. Generally, these operations are performed according to the methods and processes described in accordance with aspects of the present disclosure. In some cases, the operations described herein are composed of various substeps, or are performed in conjunction with other operations.

At operation 905, a user provides a text prompt describing content to be included in a generated media item. For example, a user may provide the prompt “a person playing with a cat”. In some examples, guidance can be provided in a form other than text, such as via an image, a sketch, or a layout.

At operation 910, the system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

At operation 915, a noise map is initialized that includes random noise. The noise map may be in a pixel space or a latent space. By initializing a media item with random noise, different variations of a media item including the content described by the conditional guidance can be generated.

At operation 920, the system generates a media item based on the noise map and the conditional guidance vector. For example, the media item may be generated using a reverse diffusion process as described with reference to FIG. 10.

### Example Reverse Diffusion Inference

FIG. 10 shows a diffusion process 1000 according to aspects of the present disclosure. In some examples, diffusion process 1000 describes an operation of the diffusion model 208 described with reference to FIG. 2, such as the reverse diffusion process 725 of guided diffusion model 700 described with reference to FIG. 7.

As described above with reference to FIG. 7, using a diffusion model can involve both a forward diffusion process 1005 for adding noise to a media item (or features in a latent space) and a reverse diffusion process 1010 for denoising the media item (or features) to obtain a denoised media item. The forward diffusion process 1005 can be represented as q(xₜ|xₜ₋₁), and the reverse diffusion process 1010 can be represented as p(xₜ₋₁|xₜ). In some cases, the forward diffusion process 1005 is used during training to generate media items with successively greater noise, and a neural network is trained to perform the reverse diffusion process 1010 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1010, the model begins with noisy data x_{T}, such as a noisy media item 1015 and denoises the data to obtain the p(xₜ₋₁|xₜ). At each step t−1, the reverse diffusion process 1010 takes xₜ, such as first intermediate media item 1020, and t as input. Here, t represents a step in the sequence of transitions associated with different noise levels, The reverse diffusion process 1010 outputs xₜ₋₁, such as second intermediate media item 1025 iteratively until x_{T} reverts back to x₀, the original media item 1030. The reverse process can be represented as:

p_{θ}(xₜ₋₁|xₜ):=N(xₜ₋₁;μ_{θ}(xₜ,t),Σ_{θ}(xₜ,t). (1)

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x_{T})=N(x_{T}; 0, I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and x represents the generated item with high quality.

### Example Training of a Machine-Learning Model

FIG. 11 is a flow diagram depicting an algorithm as a step-by-step procedure 1100 in an example implementation of operations performable for training a machine-learning model. In some embodiments, the procedure 1100 describes an operation of the training described for configuring the diffusion model 208 as described with reference to FIG. 4. The procedure 1100 provides one or more examples of generating training data, use of the training data to train a machine-learning model, and use of the trained machine-learning model to perform a task.

To begin in this example, a machine-learning system collects training data (block 1102) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1104) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1106). Initialization of the machine-learning model includes selecting a model architecture (block 1108) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1110). The loss function is utilized to measure a difference between an output of the machine-learning model (i.e., predictions) and target values (e.g., as expressed by the training data) to be used to train the machine-learning model. Additionally, an optimization algorithm is selected (block 1112) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1116) examples of which includes initializing weights and biases of nodes to improve efficiency in training and computational resources consumption as part of training. Hyperparameters are also set (block 1114) that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1118) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1120), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1120), the procedure 1100 continues training of the machine-learning model using the training data (block 1118) in this example.

If the stopping criterion is met (“yes” from decision block 1120), the trained machine-learning model is then utilized to generate an output based on subsequent data (block 1122). The trained machine-learning model, for instance, is trained to perform a task as described above and therefore once trained is configured to perform that task based on subsequent data received as an input and processed by the machine-learning model.

### Example System and Device

FIG. 12 illustrates an example system 1200 that includes an example computing device 1202 that is representative of one or more computing systems and/or devices that are usable to implement the various techniques described herein. This is illustrated through the inclusion of the video generation service 116. The computing device 1202 is configurable, for example, as a server of a service provider, a device associated with a client (e.g., a client device), an on-chip system, and/or any other suitable computing device or computing system.

The example computing device 1202, as illustrated, includes a processing system 1204, one or more computer-readable media 1206, and one or more I/O interfaces 1208 that are communicatively coupled, one to another. Although not shown, the computing device 1202 further includes a system bus or other data and command transfer system that couples the various components from one to another. For example, a system bus includes any combination of different bus structures, such as a memory bus or memory controller, a peripheral bus, a universal serial bus, and/or a processor or local bus that utilizes various bus architectures. A variety of other examples are also contemplated, such as control and data lines.

The processing system 1204 is representative of the functionality to perform one or more operations using hardware. Accordingly, the processing system 1204 is illustrated as including hardware elements 1210 that are configured as processors, functional blocks, and so forth. This includes example implementations in hardware as an application specific integrated circuit or other logic device formed using one or more semiconductors. The hardware elements 1210 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 1206 is illustrated as including memory/storage 1212. Memory/storage 1212 represents memory or storage capacity associated with one or more computer-readable media. In one example, the memory/storage 1212 includes volatile media (such as random access memory (RAM)) and/or nonvolatile media (such as read-only memory (ROM), Flash memory, optical disks, magnetic disks, and so forth). In another example, the memory/storage 1212 includes fixed media (e.g., RAM, ROM, a fixed hard drive, and so on) as well as removable media (e.g., Flash memory, a removable hard drive, an optical disc, and so forth). The computer-readable media 1206 is configurable in a variety of other ways, as further described below.

Input/output interface(s) 1208 are representative of functionality to allow a user to enter commands and information to computing device 1202, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1202 is configurable in a variety of ways, as further described below, to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

Implementations of the described modules and techniques are stored on or transmitted across some form of computer-readable media. For example, the computer-readable media includes a variety of media accessible to the computing device 1202. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal-bearing media. The computer-readable storage media includes hardware such as volatile and non-volatile, removable and non-removable media, and/or storage devices implemented in a method or technology suitable for storage of information such as computer-readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium configured to transmit instructions to the hardware of the computing device 1202, such as via a network. Signal media typically embodies computer-readable instructions, data structures, program modules, or other data in a modulated data signal, such as carrier waves, data signals, or other transport mechanisms. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1210 and computer-readable media 1206 are representative of modules, programmable device logic, and/or fixed device logic implemented in a hardware form that is employable in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as hardware utilized to store instructions for execution, e.g., the computer-readable storage media described previously.

Combinations of the foregoing are also employable to implement various techniques described herein. Accordingly, software, hardware, or executable modules are implementable as instructions and/or logic embodied on some form of computer-readable storage media and/or by one or more hardware elements 1210. For example, the computing device 1202 is configured to implement particular instructions and/or functions corresponding to the software and/or hardware modules. Accordingly, implementation of a module that is executable by the computing device 1202 as software is achieved at least partially in hardware, e.g., through the use of computer-readable storage media and/or hardware elements 1210 of the processing system 1204. The instructions and/or functions are executable/operable by one or more articles of manufacture (for example, one or more computing devices 1202 and/or processing systems 1204) to implement techniques, modules, and examples described herein.

The techniques described herein are supportable by various configurations of the computing device 1202 and are not limited to the specific examples of the techniques described herein. This functionality is also implementable entirely or partially through the use of a distributed system, such as over a “cloud” 1214, as described below.

The cloud 1214 includes and/or is representative of a platform 1216 for resources 1218. The platform 1216 abstracts the underlying functionality of hardware (e.g., servers) and software resources of the cloud 1214. For example, the resources 1218 include applications and/or data that are utilized while computer processing is executed on servers remote from the computing device 1202. In some examples, the resources 1218 also include services provided over the Internet and/or through a subscriber network, such as a cellular or Wi-Fi network.

The platform 1216 abstracts the resources 1218 and functions to connect the computing device 1202 with other computing devices. In some examples, the platform 1216 also serves to abstract scaling of resources to provide a corresponding level of scale to encountered demand for the resources implemented via the platform. Accordingly, in an interconnected device embodiment, the implementation of functionality described herein is distributable throughout the system 1200. For example, the functionality is implementable in part on the computing device 1202 as well as via the platform 1216 that abstracts the functionality of the cloud 1214.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

What is claimed is:

1. A method comprising:
receiving, by a processing device, a first digital video having a plurality of frames depicting a reference movement of a first object and a prompt indicating a second object;
determining, by a machine-learning model, point trajectories across the plurality of frames of the first digital video that track the reference movement of the first object;
determining, by the machine-learning model, a correspondence loss that quantifies a spatial correspondence of the point trajectories; and
generating, by the machine-learning model, a second digital video as having movement of the second object based on the reference movement of the first object, the generating using the correspondence loss as a guide for maintaining the spatial correspondence across a plurality of frames of the second digital video.

2. The method of claim 1, wherein the prompt includes a text prompt in a natural language format and the machine-learning model is a text-to-video (T2V) diffusion model.

3. The method of claim 1, wherein the prompt includes an image of the second object and the machine-learning model is an image-to-video (I2V) diffusion model.

4. The method of claim 1 further comprising:
receiving a textual description of the first digital video and the first object, the textual description used by the machine-learning model to generate the second digital video.

5. The method of claim 1, wherein the point trajectories are determined using bidirectional optical flow procedure by:
extracting per-pixel features from the plurality of frames;
building four-dimensional correlation volumes for each pair of pixels; and
iteratively updating a flow field through a recurrent unit performing lookups on the four-dimensional correlation volumes.

6. The method of claim 1, wherein the correspondence loss is determined at a first time step by:
encoding the plurality of frames of the first digital video from a pixel space into a latent space to generate a latent representation of the first object;
feeding the latent representation at the first time step into a denoiser of the machine-learning model to extract latent features of the first object; and
determining the correspondence loss based on the latent features and the point trajectories.

7. The method of claim 6, wherein an updated latent representation at the first time step is generated based on gradients of the correspondence loss and used at the first time step by the denoiser of the machine-learning model.

8. The method of claim 7, wherein the updated latent representation is determined at each time step and at each denoising step in the denoiser.

9. The method of claim 1, wherein the machine-learning model is trained to minimize a diffusion loss and the correspondence loss, the diffusion loss quantifying noise removal and data reconstruction in generated videos.

10. The method of claim 1 further comprising:
presenting, by the processing device, the second digital video via a display device.

11. A system comprising:
a memory component; and
a processing device coupled to the memory component, the processing device configured to:
determine, by a machine-learning model, point trajectories across a plurality of frames of a first digital video that track a reference movement of a first object in the plurality of frames;
determine, by the machine-learning model, a correspondence loss that quantifies a spatial correspondence of the point trajectories;
generate, by the machine-learning model, a second digital video as having movement of a second object based on the reference movement of the first object, the machine-learning model using the correspondence loss as a guide for maintaining the spatial correspondence across a plurality of frames of the second digital video; and
present the second digital video via a display device.

12. The system of claim 11, wherein the machine-learning model is configured to determine the point trajectories using an optical flow procedure by:
extracting per-pixel features from the plurality of frames;
building four-dimensional correlation volumes for each pair of pixels; and
iteratively updating a flow field through a recurrent unit performing lookups on the four-dimensional correlation volumes.

13. The system of claim 11, wherein the machine-learning model is configured to determine the correspondence loss by:
encoding the plurality of frames of the first digital video from a pixel space into a latent space to generate a latent representation of the first object;
feeding the latent representation into a denoiser of the machine-learning model to extract latent features of the first object; and
determining the correspondence loss based on the latent features and the point trajectories.

14. The system of claim 13, wherein an updated latent representation at a first time step is generated based on gradients of the correspondence loss and used by the denoiser of the machine-learning model in a first denoising time step.

15. The system of claim 14, wherein the updated latent representation is determined at each time step and at each denoising step in the denoiser.

16. The system of claim 11, wherein the machine-learning model is trained to minimize a diffusion loss and the correspondence loss, the diffusion loss quantifying noise removal and data reconstruction in generated videos.

17. The system of claim 11, wherein the processing device is further configured to receive a prompt indicating the second object, the prompt including:
a text prompt in a natural language format and the machine-learning model is a text-to-video (T2V) diffusion model; or
an image of the second object and the machine-learning model is an image-to-video (I2V) diffusion model.

18. A non-transitory computer-readable storage medium storing executable instructions that, responsive to execution by a processing device, causes the processing device to perform operations comprising:
receiving a first digital video that includes a plurality of frames depicting a reference movement of a first object and a prompt indicating a second object, the prompt being a text prompt in a natural language format or an image of the second object;
determining, by a diffusion model, point trajectories across the plurality of frames of the first digital video that track the reference movement;
generating a correspondence loss using the diffusion model, the correspondence loss quantifying a spatial correspondence of the point trajectories; and
generating, by the diffusion model, a second digital video of the second object having movement based on the reference movement using the correspondence loss.

19. The non-transitory computer-readable storage medium of claim 18, wherein the correspondence loss is determined by:
encoding the plurality of frames of the first digital video from a pixel space into a latent space to generate a latent representation of the first object;
feeding the latent representation into a denoiser of the diffusion model to extract latent features of the first object; and
determining the correspondence loss based on the latent features and the point trajectories.

20. The non-transitory computer-readable storage medium of claim 19, wherein an updated latent representation is determined at each time step based on gradients of the correspondence loss and used by the denoiser of the diffusion model at each time step.
